(19) United States
(12) Patent Application Publication
(10) Pub. No.: US 2009/0050377 A1
(43) Pub. Date: Feb. 26, 2009

(54) STYLUS AND PORTABLE ELECTRONIC DEVICE USING THE SAME

(75) Inventor: WEI-LUNG LEE, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/964,799

(22) Filed: Dec. 27, 2007

(30) Foreign Application Priority Data
Aug. 20, 2007 (CN) 200710201408.5

(51) Int. Cl. G06F 3/033

(52) U.S. Cl. 178/19.01

(57) ABSTRACT

A stylus (20) used in a portable electronic device (40) includes an elastic member (22), a sleeve (23), a sliding member (24), a wire (25) and a writing member (26). The elastic member and the sliding member are received in the sleeve. The writing member is mounted on one end of the sleeve and has a center hole (264) defined therein. The wire wraps around the sliding member, with one end fastened to one end of the sliding member, and another end extending out from the center hole of the writing member. The sliding member is rotatably engaged with the sleeve. The elastic member is configured for giving a pushing force to the sliding member so as to force the sliding member to rotate.

### CROSS-REFERENCE TO RELATED APPLICATIONS

This application claims all benefits accruing under 35 U.S.C. §119 from China Patent Application No. 200710201408.5, filed on Aug. 20, 2007 in the China Intellectual Property Office, the disclosure of which is incorporated herein by reference.

### BACKGROUND OF THE INVENTION

1. Field of the Invention

The present invention relates to styluses, particularly to a stylus applied to a portable electronic device and a portable electronic device using the same.

2. Description of Related Art

Many portable electronic devices, such as mobile phones, PDAs, are equipped with a stylus. The stylus can be used to input and send messages simply by clicking/contacting on a panel of the portable electronic device.

Referring to FIG. 1, a typical stylus 10 used in a portable electronic device 30 includes a tube 11, a sliding member 12 and a latching member 13. The latching member 13 is mounted on one end of the sliding member 12. An elastic member 111 is set in the tube 11. The sliding member 12 is slidingly received in the tube 11, with one end thereof resisting the elastic member 111. The latching member 13 has a cylindrical main body 132 and a rib 131. The rib 131 protrudes from the main body 132 allowing the user to easily pull out the stylus 10. The portable electronic device 30 has a receiving cavity 31 defined therein. The receiving cavity 31 is defined by an inner circular wall of the portable electronic device 30. The receiving cavity 31 is configured for receiving the stylus 10. The length of the receiving cavity 31 is smaller than the stylus 10 in original shape. The open end of the receiving cavity 31 is interference fit to the latching member 13, so that the stylus 10 can stably received in the receiving cavity 31 by the friction between the main body 132 and the inner circular wall of the portable electronic device 30.

When storing the stylus 10, the tube 11 is first inserted into the receiving cavity 31, and the latching member 13 is then pressed down into the receiving cavity 31. Accordingly, the elastic member 111 is pressed down by the sliding member 12, and the sliding member 12 slides into the tube 11. The latching member 13 is pushed into the open end of the receiving cavity 31. When the pressure applied to the latching member 13 is released, the friction between the latching member 13 and the inner circular wall of the portable electronic device 30 counteracts the elastic force of the sliding member 12. Thus, the stylus 10 is stably received in the receiving cavity 31.

In use, the user pull out the latching member 13 from the receiving cavity 31 via the rib 131 thereof. Thus, the frictional force applied on the inner circular wall by the latching member 13 is removed. Due to the elastic member 111 rebounding to its original shape, the sliding member 12 resisted by the elastic member 111 is pushed outward. Therefore, the user can easily remove the stylus 10 from the receiving cavity 31.

However, the main body 132 of the latching member 13 and the inner circular wall of the portable electronic device might suffer from wear and tear after repeated usage, which reduces the friction between the main body 132 and the inner circular wall. Therefore, friction therebetween will not prevent the elastic member 111 from rebounding to its original shape, thus the stylus 10 cannot be stably received in the receiving cavity 31. In addition, the user may forget to put the stylus 10 back into the receiving cavity 31 after usage, so that the stylus 10 can easily be misplaced/lost.

Therefore, a new stylus is desired in order to overcome the above-described problems.

### SUMMARY OF THE INVENTION

In one embodiment thereof, a stylus applied to a portable electronic device includes an elastic member, a sliding member, a sleeve, a writing member and a wire. The elastic member and the sliding member are received in the sleeve. The writing member is mounted on one end of the sleeve and has a center hole defined therein. The wire wraps around the sliding member. One end of the wire is fastened to one end of the sliding member, and another end of the wire extends out from the center hole of the writing member. The sliding member is rotatably engaged with the sleeve. The elastic member is configured for providing a pushing force to the sliding member so as to rotate the sliding member.

Other advantages and novel features will become more apparent from the following detailed description when taken in conjunction with the accompanying drawings.

### BRIEF DESCRIPTION OF THE DRAWINGS

Many aspects of the stylus can be better understood with reference to the following drawings. The components in the drawings are not necessarily drawn to scale, the emphasis instead being placed upon clearly illustrating the principles of the present stylus. Moreover, in the drawings, like reference numerals designate corresponding parts throughout the several views, wherein:

FIG. 1 is an isometric view of a conventional stylus used in a portable electronic device;

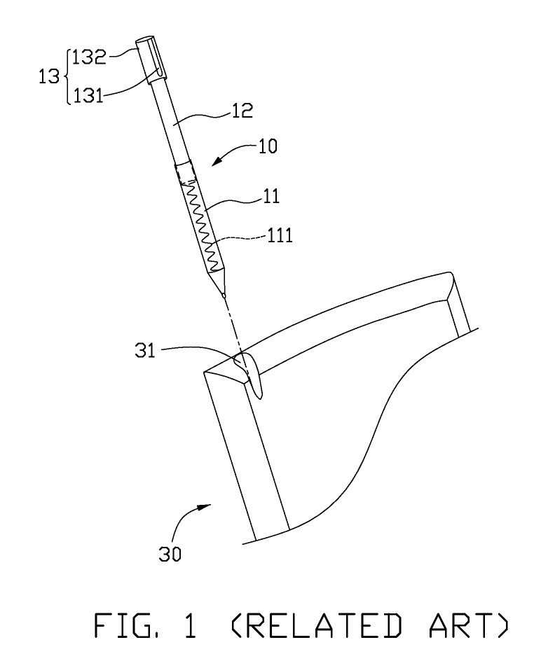

FIG. 2 is an isometric view of a portable electronic device with a stylus, in accordance with an embodiment of the present invention;

FIG. 3 is an isometric, exploded view of the typical stylus shown in FIG. 2;

FIG. 4 is an isometric, cut-away view of a sleeve of the typical touch pen shown in FIG. 3;

FIG. 5 is similar to FIG. 3, but showing another aspect;

FIG. 6 is an isometric, assembled, partial cut-away view of the stylus shown in FIG. 2;

FIG. 7 is an isometric, assembled view of the portable electronic device shown in FIG. 2; and

FIG. 8 is an isometric view of the portable electronic device shown in FIG. 2, showing the stylus in use.

### DETAILED DESCRIPTION OF THE INVENTION

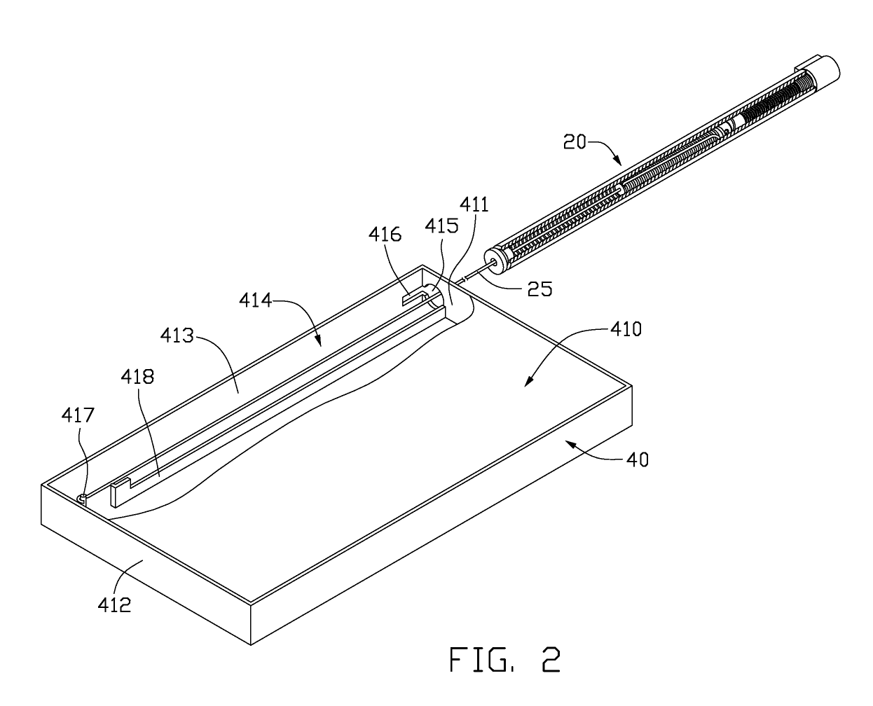

Referring to FIG. 2, a stylus 20 is applied to a portable electronic device 40, in accordance with an embodiment of the present invention. The portable electronic device 40 includes a housing 410. The housing 410 has a top wall 411, a bottom wall 412 and a sidewall 413 connecting the top wall 411 and the bottom wall 412. A clapboard 418 protrudes from the top wall 411 and extends toward the bottom wall 412. A receiving cavity 414 is defined between the sidewall 413 and the clapboard 418 configured for receiving the stylus 20. The receiving cavity 414 extends to the top wall 411, and the top wall 411 has a hole 415 communicating with the receiving cavity 414. A latching slot 416 is defined in the sidewall 413 and communicates with the hole 415 of the top wall 411. A locating pin 417 is positioned at one end of the receiving cavity 414, adjacent to the bottom wall 412 of the housing 410.

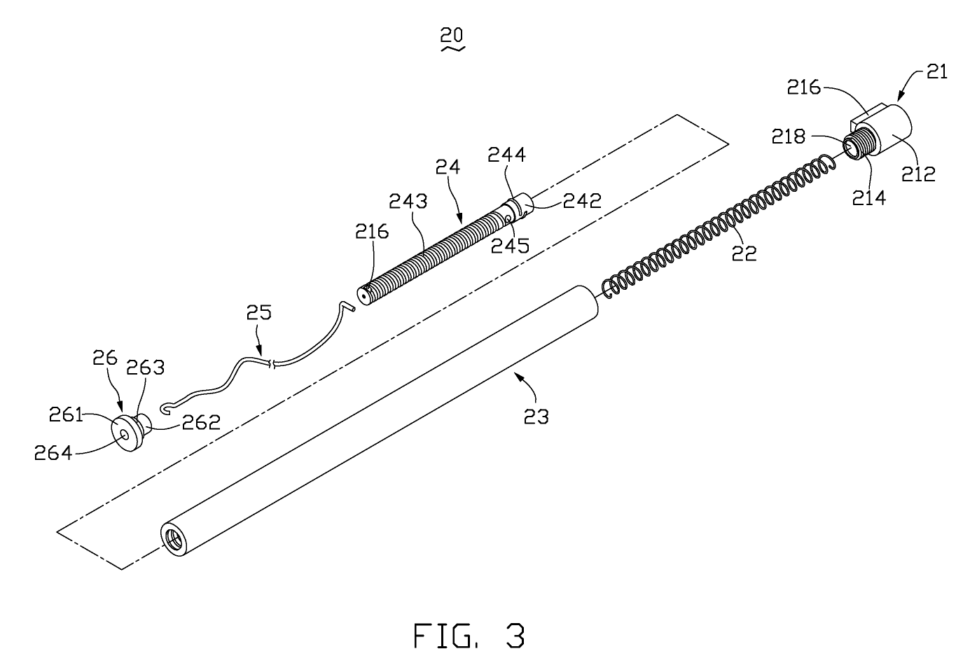

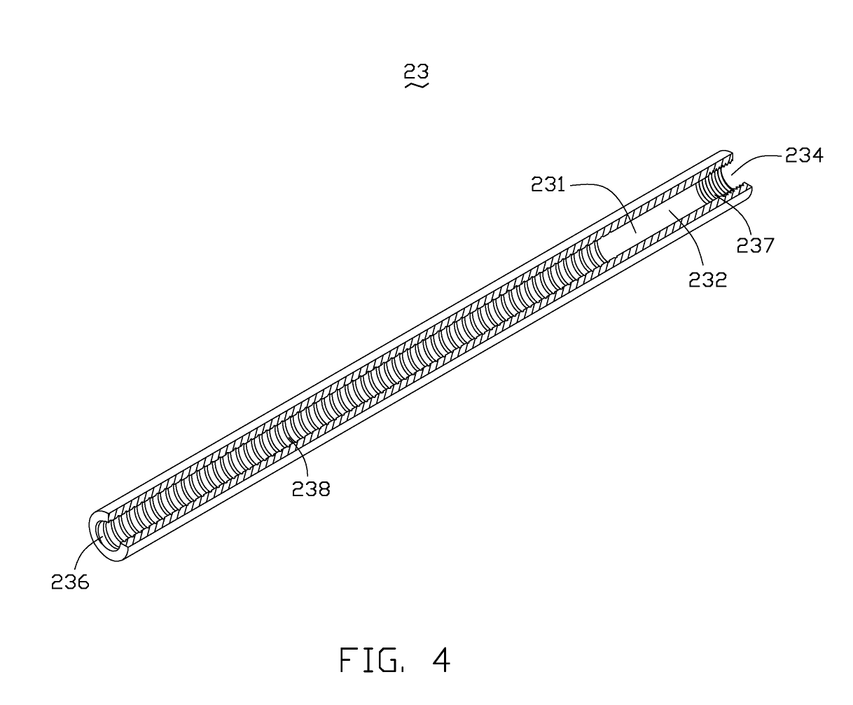

Referring to FIG. 3 and FIG. 4, the stylus 20 includes a latching member 21, an elastic member 22, a sleeve 23, a sliding member 24, a wire 25 and a writing member 26. The sleeve 23 is configured for receiving the elastic member 22 and the sliding member 24. The sleeve 23 has a first open end 234 and a second open end 236 for respectively positioning the latching member 21 and the writing member 26 therein.

The latching member 21 has a main body 212, an outer screw portion 214 and a latching block 216. The main body 212 is a column. The outer screw portion 214 directly extends from a bottom surface of the main body 212. A diameter of the outer screw portion 214 is smaller than that of the main body 212. The latching block 216 protrudes from a peripheral surface of the main body 212, which is configured for allowing the user to easily pull out the stylus 10 from the portable electronic device 40. A recess 218 is defined in an end surface of the outer screw portion 214, configured for receiving one end of the elastic member 22.

The elastic member 22 may, advantageously, be a helical spring or a torsion spring. One end of the elastic member 22 is received in the recess 218 of the latching member 21, and the other end thereof resists the sliding member 24.

Particularly referring to FIG. 4, the sleeve 23 defines a channel 232 extending therethrough and has an inner peripheral surface 231 surrounding the channel 232. An inner screw portion 237 and a sliding slot portion 238 are formed in the inner peripheral surface 231. The inner screw portion 237 extends to the first open end 234 of the sleeve 23, and is configured for engaging with the outer screw portion 214 of the latching member 21. The sliding slot portion 238 extends in a helical manner to the second open end 236 of the sleeve 23.

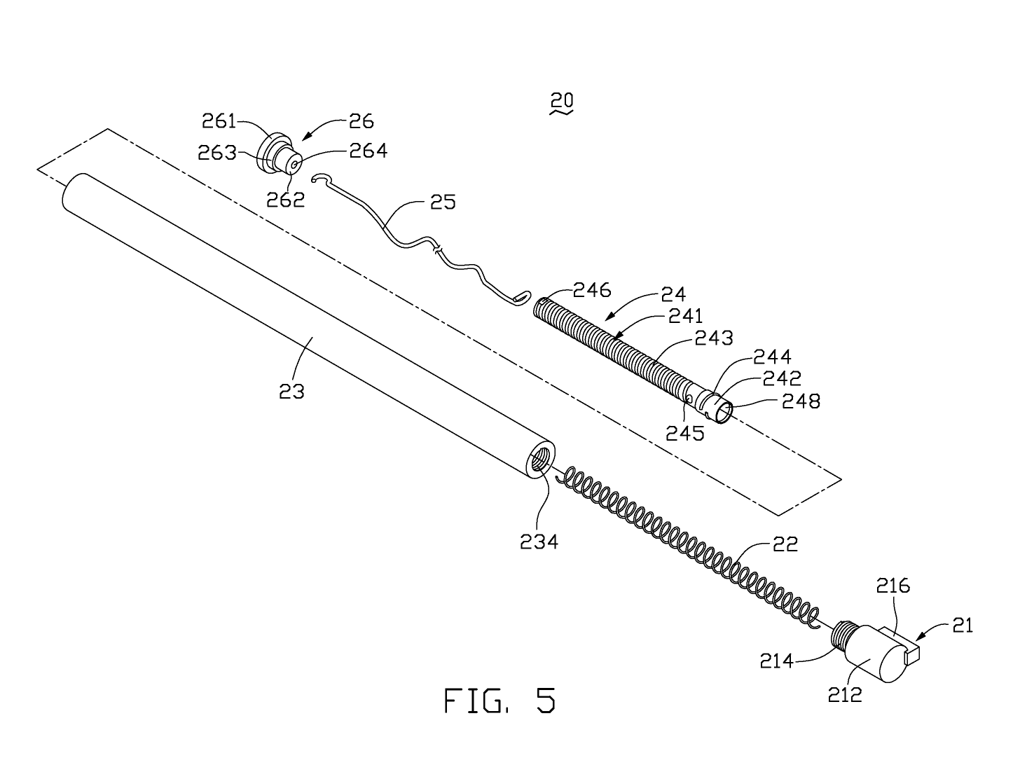

Also referring to FIG. 5, the sliding member 24 is approximately a hollow column, and has an outer surface 242. A helical slot 243 is defined in the outer surface 242 and extends to one end of the sliding member 24. The helical slot 243 is configured for receiving the wire 25. A helical rib 244 protrudes from the outer surface 242 at another end of the sliding member 24, and is configured for engaging with the sliding slot portion 238 of the sleeve 23. A latching hole 245 is defined at one end of the helical slot 243 and is adjacent to the helical rib 244. A guiding hole 246 is defined at another end of the helical slot 243 through an end surface of the sliding member 24. The guiding hole 246 is configured for receiving the wire 25. It is understood that the number of the helical rib 244 may be increased, and the number of the sliding slot portion 238 of the sleeve 23 can be changed accordingly. A receiving groove 248 is at one end of the sliding member 24, and is configured for receiving the elastic member 22.

The writing member 26 has a touching portion 261, a locking portion 262 and a connecting portion 263 connecting the touching portion 261 and the locking portion 262. The touching portion 261 is used to touch a display 42 of the portable electronic device 40, so that the stylus 20 can be used to input and send messages simply by clicking/contacting on the display 42 of the portable electronic device 40. A center hole 264 is defined at a central area of the writing member 26. The touching portion 261 may, advantageously, be made of soft plastic material, such as thermo plastic urethane, so as to avoid damaging the display 42.

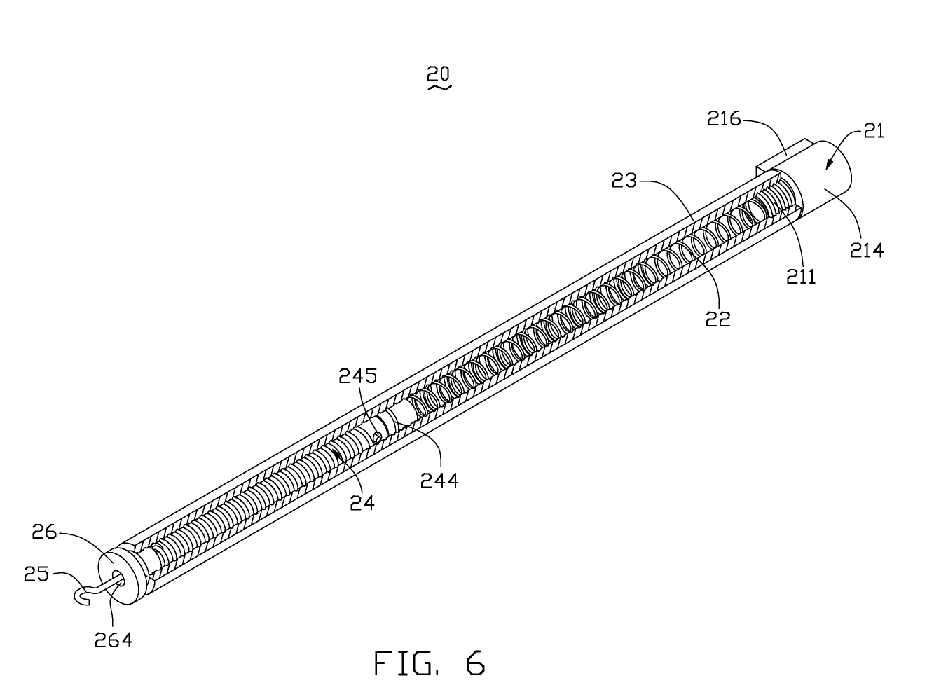

Also referring to FIG. 6, in assembly of the stylus 20, firstly, one end of the wire 25 is inserted into the latching hole 245 of the sliding member 24 and is adhered to the sliding member 24 by glue or other means. The wire 25 then wraps around the sliding member 24 along the helical slot 243, with another end of the wire 25 passing the through hole 246 of the sliding member 24. After that, the sliding member 24 is inserted into the second open end 236 of the sleeve 23, and is then rotated into the sleeve 23 by engagement of the helical rib 244 and the sliding slot portion 238. The elastic member 22 is set in the sleeve 23 via the first open end 234 of the sleeve 23, and one end thereof is received in the receiving groove 248 of the sliding member 24. The free end of the wire 25 passes through the center hole 264 of the writing member 26. The locking portion 262 is inserted into the channel 232 of the sleeve 23, and is stably mounted in the sleeve 23 by friction between the locking portion 262 and the inner peripheral surface 231 of the sleeve 23. At last, the latching member 21 is rotated into the sleeve 23 by the engagement of the outer screw portion 214 thereof and the inner screw portion 237 of the sleeve 23, with another end of the elastic member 22 being received in the recess 218 of the latching member 21.

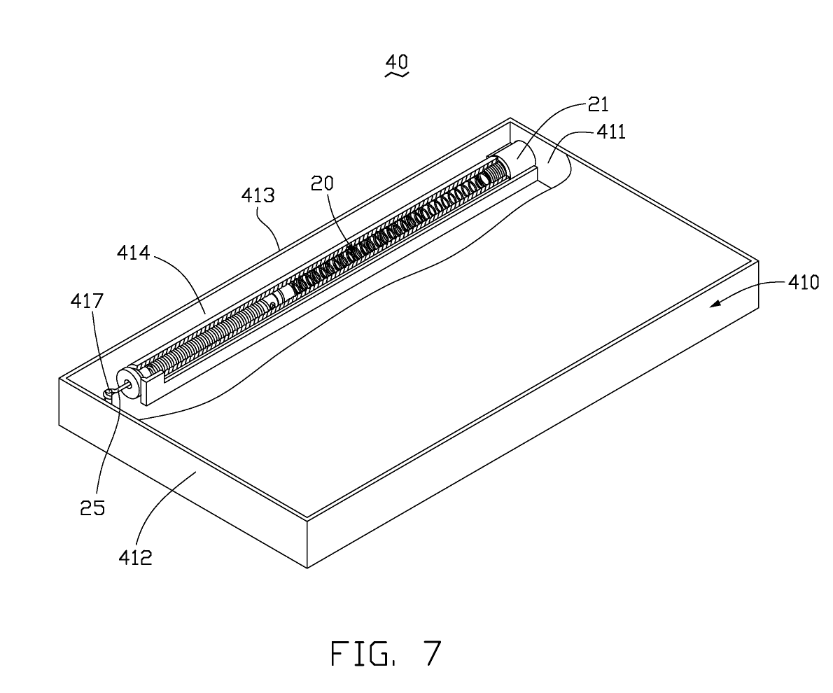

Referring to FIG. 7, in assembly of the stylus 20 to the portable electronic device 40, firstly, the free end of the wire 25 is inserted into the receiving cavity 414 and fastened to the locating pin 417. The stylus 20 is then inserted into the receiving cavity 414, and the latching block 216 of the latching member 21 is engaged in the latching slot 416. The stylus 20 is received in the receiving cavity 414 of the portable electronic device 40.

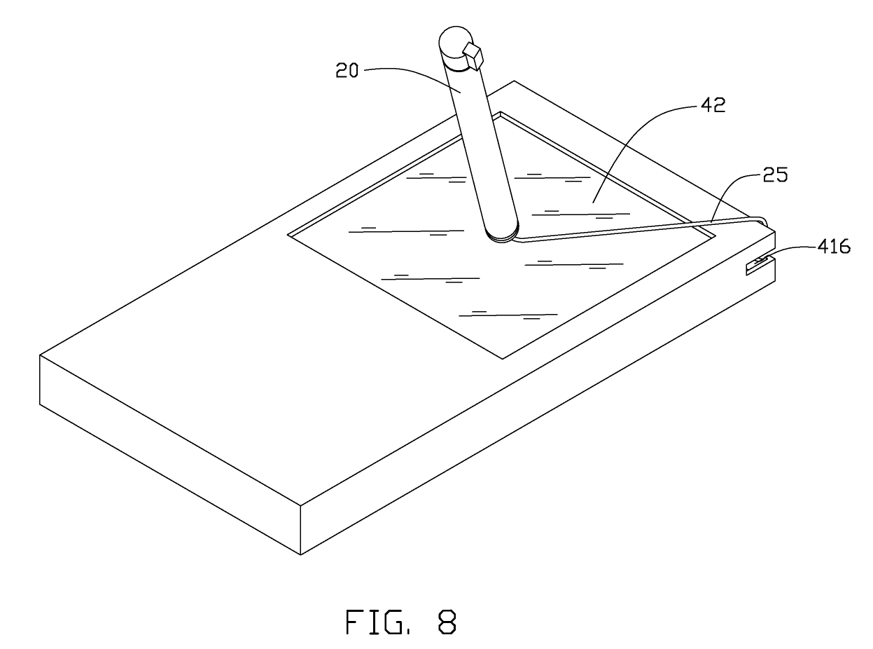

Referring to FIG. 8, in use, the stylus 20 is taken out from the receiving cavity 414 of the portable electronic device 40. The wire 25 is gradually drawn out from the center hole 264 of the writing member 26, and is firm. The movement of the firm wire 25 applies a torsional force on the sliding member 24. The sliding member 24 rotates toward the elastic member 22 via the engagement of the helical rib 244 and the sliding slot portion 238 of the sleeve 23. At the same time, the sliding member 24 presses the elastic member 22 down. The stylus 20 can be used to input and send messages simply by clicking/contacting on the display 42 of the portable electronic device 40. During use, the torsional force from the wire 25 and the pushing force from the elastic member 22 tend to keep balance on the sliding member 24. Therefore, when the wire 25 is loose, the torsional force is reduced, and the elastic member 22 pushes the sliding member 24 to rotate toward the writing member 26. Accordingly, the loose portion of the wire 25 wraps around the sliding member 24 and become firm.

After use, the writing member 26 is inserted into the receiving cavity 414 of the portable electronic device 40. When the stylus 20 is released, the elastic member 22 rebounds to its original shape and pushes the sliding member 24 rotate toward the writing member 26. The wire 25 wraps around the sliding member 24 in the sliding slot portion 238, and the stylus 20 slides into the receiving cavity 414. At last, the latching member 21 is inserted into the hole 415 of the top wall 411, and the latching block 216 thereof is engaged in the latching slot 416.

In an alternative embodiment, the latching member 21 and the inner screw portion 237 are omitted, and one end of the elastic member 22 is secured at the sleeve 23 by soldered/welded/adhibitted means.

A main advantage of the stylus 20 is that the wire 25 is fastened to the portable electronic device 40, so as to avoid the stylus 20 from being misplaced/lost. In addition, the wire 25 can automatically wrap around the sliding member 24 due to the elastic force of the elastic member 22, so that the stylus 20 can automatically slide into the receiving cavity 414 of the portable electronic device 40, which is convenient to the user.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A stylus comprising:
an elastic member;
a sliding member;
a sleeve configured for receiving the elastic member and the sliding member;
a writing member mounted on one end of the sleeve, the writing member having a center hole defined therein; and
a wire wrapping around the sliding member, one end of the wire fastened to one end of the sliding member, another end of the wire extending out from the center hole of the writing member;
wherein, the sliding member is rotatably engaged with the sleeve, the elastic member is configured for giving a pushing force to the sliding member so as to force the sliding member to rotate.

2. The stylus as claimed in claim 1, wherein a helical rib protrudes from an outer surface of the sliding member, a sliding slot portion is defined in an inner surface of the sleeve, and the sliding slot portion is configured for engaging with the helical rib.

3. The stylus as claimed in claim 2, wherein the outer surface of the sliding member has a helical slot defined therein, and the helical slot is configured for receiving the wire.

4. The stylus as claimed in claim 3, wherein the sliding member has a latching hole defined at one end of the helical slot, the latching hole being configured for receiving one end of the wire.

5. The stylus as claimed in claim 4, wherein the sliding member has a guiding hole defined at another end of the helical slot, the guiding hole being defined through a bottom surface of the sliding member and being configured for receiving the wire.

6. The stylus as claimed in claim 4, wherein the wire is fastened to the sliding member by means of soldering or welding or adhered one end of the wire in the latching hole.

7. The stylus as claimed in claim 1, further comprising a latching member, wherein the latching member includes an outer screw portion, an inner screw portion is form at one end of the sleeve, and the inner crew portion of the sleeve is configured for engaging with the outer screw portion of the latching member.

8. The stylus as claimed in claim 7, wherein a receiving slot is defined in a bottom surface of the outer screw portion of the latching member, the receiving slot being configured for receiving one end of the elastic member.

9. The stylus as claimed in claim 8, wherein the sliding member has a latching hole defined in one end of, the latching hole being configured for receiving another end of the elastic member.

10. The stylus as claimed in claim 8, wherein the latching member further comprising a main body, a latching block protruding from the main body.

11. The stylus as claimed in claim 1, wherein the writing member comprises a touch portion, a latching portion and a connecting portion connecting with the touch portion and the latching portion, and the latching portion is configured for being engaged in one end of the sleeve.

12. The stylus as claimed in claim 11, wherein the touch portion is made of soft plastic material.

13. A portable electronic device comprising:
a stylus including:
a sliding member;
an elastic member configured for providing a pushing force to the sliding member so as to force the sliding member to rotate;
a sleeve configured for receiving the elastic member and the sliding member, the sliding member being rotatably engaged with the sleeve;
a writing member mounted on one end of the sleeve, the writing member having a center hole defined therein; and
a wire wrapping around the sliding member, one end of the wire fastened to one end of the sliding member, another end of the wire extending out from the center hole of the writing member;
a housing defining a receiving cavity configured for receiving the stylus, a latching pin being positioned at one end of the receiving cavity for fastening one end of the wire;
a display mounted on the housing.

14. The portable electronic device as claimed in claim 13, wherein the stylus further comprises a latching member, the latching member includes a latching block, and the housing has a latching slot defined in a sidewall thereof, the latching slot being configured for engaging with the latching block.

15. The portable electronic device as claimed in claim 13, wherein a helical rib protrudes from an outer surface of the sliding member, and the sleeve has a sliding slot portion is defined in an inner surface thereof, the sliding slot portion being configured for engaging with the helical rib.

16. The portable electronic device as claimed in claim 14, wherein the sliding member has a helical slot is defined in the outer surface thereof, the helical slot being configured for receiving the wire.

17. The portable electronic device as claimed in claim 16, wherein the sliding member has a latching hole is defined at one end of the helical slot, the latching hole being configured for receiving one end of the wire.

18. The portable electronic device as claimed in claim 17, wherein the sliding member has a guiding hole defined at another end of the helical slot, the guiding hole being through a bottom surface of the sliding member and being configured for receiving the wire.

19. The portable electronic device as claimed in claim 14, wherein the latching member further includes an outer screw portion, an inner screw portion is form at one end of the sleeve, and the inner crew portion of the sleeve is configured for engaging with the outer screw portion of the latching member.

20. The portable electronic device as claimed in claim 13, wherein the writing member comprises a touch portion, a latching portion and a connecting portion connecting with the touch portion and the latching portion, and the latching portion is configured for being engaged in one end of the sleeve.
